(19) United States
(12) Patent Application Publication
(10) Pub. No.: US 2007/0258802 A1
(43) Pub. Date: Nov. 8, 2007

(54) Vibration isolator for crawler type vehicle

(75) Inventor: Hiroshi Fukaya, Asaka-shi (JP)

Correspondence Address: BROWDY AND NEIMARK, P.L.L.C.;624 NINTH STREET, NW, SUITE 300, WASHINGTON, DC, 20001-5303, US

(73) Assignee: Imec Co., Ltd., Asaka-shi (JP)

(21) Appl. No.: 11/594,840

(22) Filed: Nov. 9, 2006

(30) Foreign Application Priority Data
May 2, 2006 (JP) 2006-003357

(51) Int. Cl. B66F 9/00

(52) U.S. Cl. 414/680

(57) ABSTRACT

In order to prevent vehicle body of a truck-loader type from causing undesirable vibrations and noises during its running, improvement is effected on its construction, so as to reduce and absorb vibrations and noises.

For solving such problem, a truck-roller 1 to be pivotally supported on the truck frame b which is mounted on both left and right sides of the vehicle body a of the truck-loader type vehicle is shaped individually and separately in its inner wheel 1a and outer wheel 1b; then, these inner wheel 1a and outer wheel 1b are formed in a spacer D between an outer peripheral surface of the inner wheel 1a and an inner peripheral surface of the outer wheel 1b, to thereby be assembled into the truck-roller 1. In this way, undesirable vibrations are absorbed by the elastic material 2 filled in the spacer D.

### BACKGROUND OF THE INVENTION

This invention relates to a truck-loader type (or crawler type) vehicle, and more particularly it is concerned with an improvement in such vibration isolator for suppressing vibrations to occur in the vehicle body during its travelling.

Concretely describing, a truck-loader (or crawler) type vehicle, as shown in FIG. 1 of the accompanying drawing illustrating its one example, is in such a construction that a truck frame b is mounted on both left and right sides of the vehicle body a, and a sprocket d to be driven by an HST pump p (hydraulically started transmission pump), which is operated by an engine E mounted on the upper surface side of the above-mentioned vehicle body a, is pivotally supported; then, a front idler e is pivotally supported on the front end part of the above-mentioned truck frame b, while a guide roller f is pivotally supported on the rear end side of the truck frame. Then, on the lower surface side, a plurality of truck-rollers 1 are pivotally supported in parallel rows on the front-and-back, and a rubber crawler g is extended in an endless fashion on and around the truck-rollers; and then, on the upper surface side of the vehicle body a, there is mounted a cabin h and a boom j equipped with a bucket I; within the above-mentioned cabin h, there are provided an operator's seat k and a travelling lever l. With this construction, a boom cylinder n and a bucket cylinder o are operated by regulating a control valve m as the actuating pump, which is coaxial with the HST pump functioning as the hydraulic source, to raise, lower, or rotate the boom j, thereby scooping up mud and sand.

Also, with rotation of a bucket I, the earthen material as scooped up is carried to a desired location by causing the vehicle body a to travel with the driving of the sprocket d, followed by unloading the earthen material as conveyed.

This truck-loader (or crawler) type vehicle functions in such a manner that the inner surface side of the rubber crawler g which rotates endlessly with the bottom surface side of its outer peripheral surface being kept in contact with the ground, to thereby cause the iron-made front idler e and the truck-roller 1 to travel in rotation, thus making the vehicle body a to run, accompanying undesirable concussion in the vehicle body a during its traveling, and also causing unbearable noises due to its vibration.

In particular, the iron-made truck-roller 1 which is pivotally supported on the lower surface side of the truck frame b rotates in direct contact with the upper surface of the inside of the lower rotating side of the rubber crawler g, in a state of its being under weight load of the vehicle body a, through its truck frame b. Therefore, when the lower rotating side of the rubber crawler g moves up-and-down following the irregular (or uneven) surface of the road, this truck-roller 1 moves upward in a manner to push up the vehicle body a, while it moves downward by its being pushed down with the weight load of the vehicle body a, thereby causing vehicle body a to vibrate.

Further, when the ground-contact surface at the lower rotational side of the rubber crawler g moves in conformity to the irregularity of the road surface, this movement does not conform to the accurate vertical direction, but accompanies the movement in the lateral direction, the truck-roller 1 receives a stress in the thrust direction, tending to oscillate in the left and right directions, thereby causing vibration and impact noise.

It is therefore an object of the present invention to solve a point of problem which has been inherent in the conventional apparatus of this sort, such that, for preventing vibrations and noises from occurring in the vehicle body during running of the truck-loader (crawler) type vehicle, such vibrations and noises are absorbed and reduced by improving the mode of construction in such truck-roller.

### SUMMARY OF THE INVENTION

According to the present invention, in one aspect thereof, there is provided a vibration isolating device for a truck-roller (crawler) type vehicle, said device being characterized in that a truck-roller 1 to be pivotally supported on a truck frame b mounted on both left and right sides of the vehicle body a is divided into an inner wheel 1a and an outer wheel 1b, each being shaped individually and separately, said inner wheel 1a and an outer wheel 1b being joined together between an outer peripheral surface of said inner wheel 1a and an inner peripheral surface of said outer wheel 1b with a spacer D being interposed therebetween; then an elastic material 2 made of rubber or the like, in a ring-shape being fitted into said spacer D under pressure, with which elastic material said inner wheel 1a and said outer wheel 1b being integrally joined together so as to absorb vibrations by means of the elastic material 2 filled in the spacer D.

According to the present invention, in another aspect thereof, there is provided means for solving the above-mentioned problem, said means comprising a vibration isolating device for a truck-loader type vehicle, as set forth in claim 1, said vibration isolating device being characterized in that said spacer D between said outer peripheral surface of said inner wheel 1a and an inner peripheral surface of said outer wheel 1b, where the elastic material 2 such as rubber or the like, is to be filled, said spacer D being formed in a shape which runs along a circular arc having a large radius of curvature having its center point outside said outer wheel 1b, and being formed in a shape with the outer peripheral surface of the inner wheel 1a and the inner peripheral surface of the outer wheel 1b being in parallel each other.

Further, according to the present invention, the bottom surface of the rubber crawler g moves in a wavy shape due to irregularity (concavity and convexity) of the road surface, whereby when the truck-roller 1 pivotally supported on the truck frame b becomes fluctuated in the up-and-down direction, the elastic material 2 such as rubber, etc. filled in the spacer D formed between the inner wheel 1a and outer wheel 1b of the truck-roller 1 function to effectively absorb the vibration by its elasticity, whereby the vibrations occurring in the vehicle body a during its running is suppressed at its portions which constitutes the principal source of generation of such vibration, thereby becoming able to effectively suppress the vibrations to be generated.

And yet, the truck-roller 1 according to the present invention can be divided into the inner wheel 1a and outer wheel 1b, and the vibration isolating means which is made of the elastic material 2 such as rubber, etc., and filled inbetween these inner wheel 1a and outer wheel 1b make it possible not to provide the vibration isolating mechanism at the pivotal support part of the supporting axle 3 of the truck-roller 1, hence the overall construction of the vehicle body a can be simplified.

### BEST MODE TO PRACTICE THE PRESENT INVENTION

In the following, a preferred embodiment of the present invention will be described in detail in reference to the accompanying drawing.

### BRIEF DESCRIPTION OF THE ACCOMPANYING DRAWING

FIG. 1 is a side elevational view of a truck-loader;

FIG. 2 is a side elevational view of the truck-loader, in which a truck-roller according to the present invention is incorporated;

FIG. 3 is a side elevational view, in longitudinal cross-section, showing the truck-roller, which is incorporated in the truck-loader shown in FIG. 2; and

FIG. 4 is a side elevational view of the truck-roller shown in FIG. 3.

### DETAILED DESCRIPTION OF THE PREFERRED EMBODIMENT

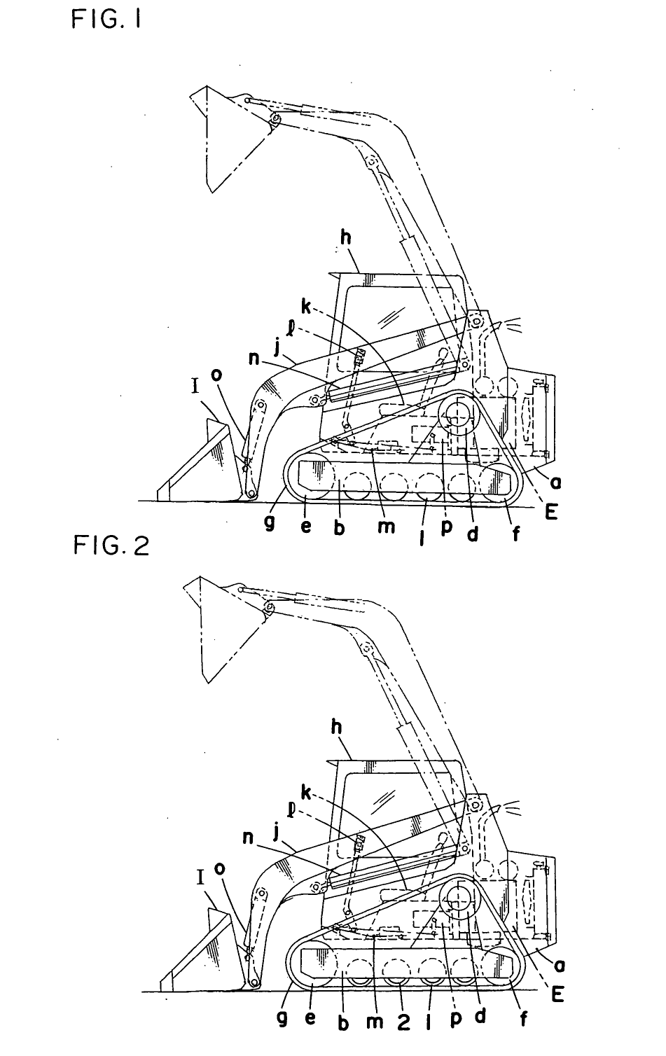

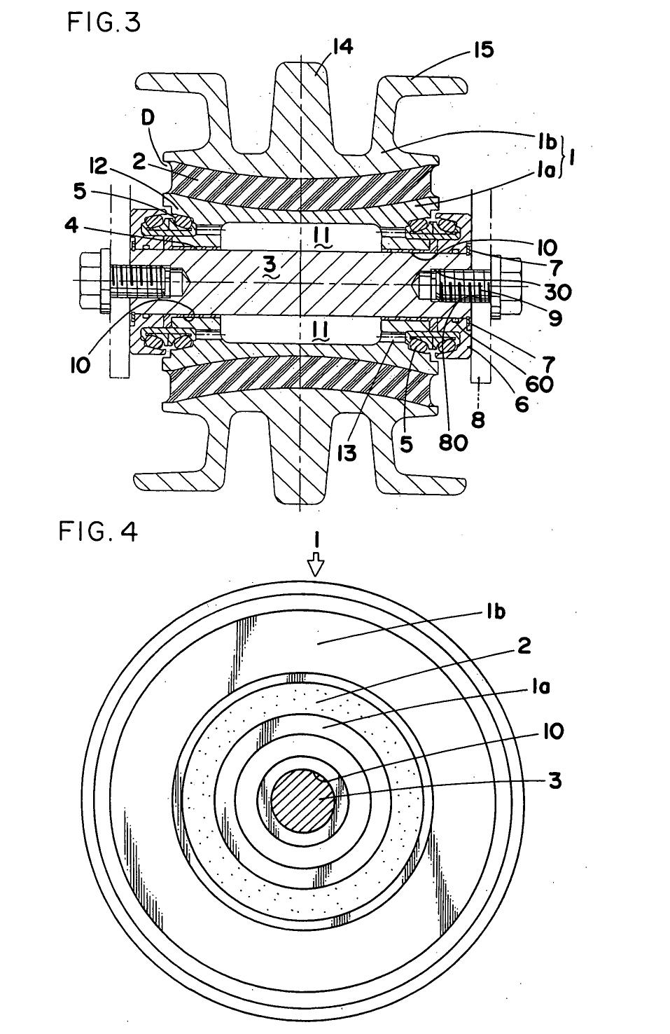

FIG. 2 illustrates a side elevational view of the body of the truck-loader type vehicle, in which the truck-roller according to the present invention has been incorporated; and FIG. 3 is a front view, in longitudinal cross-section of the truck-roller which is incorporated in the vehicle body shown in FIG. 2.

In these figures of drawing, a reference letter a designates the vehicle body; a reference letter b indicates a truck frame supported on both left and right sides of the vehicle body a; a reference letter e designates an idler which is pivotally held on the front end side of the truck frame; a reference letter f indicates a guide roller which is pivotally supported on the rear end side of the truck frame; a reference numeral 1 designates a truck-roller according to the present invention, which is pivotally supported on the lower surface side at the intermediate part of the truck frame b, at its front and rear thereof; a reference letter g designates a rubber crawler which is extended endlessly on and around the abovementioned idler e, sprocket d and the outer periphery of the truck-roller 1.

This truck-loader (crawler) type vehicle according to this embodiment is nothing but the truck-loader as exemplified in FIG. 1 above, and, with the exception of the truck-roller 1 which is pivotally supported on the lower surface side of the truck frame b fittingly mounted on both left and right sides of the vehicle body a is the exactly same construction as that of the truck-loader shown in FIG. 1 above. Therefore, any detailed explanations for the structural member and their description will be dispensed with.

Thus, as shown in FIG. 3, the truck-roller 1 is divided into its inner wheel 1a, in which a bearing hole 10 to be fitted with supporting axle 3 is formed in the shaft center, and its outer wheel 1b, in which an annular abutting surface to contact with the inner surface of the rubber crawler g on its outer peripheral surface is formed, each of these inner wheel 1a and outer wheel 1b being separately and individually shaped. And then, these inner wheel 1a and outer wheel 1b are fitted together with an annular spacer D which is concentric with the bearing hole 10, and the elastic material 2 made of rubber, etc. is fitted under pressure, followed by its being adhered integrally with the inner wall surface of the spacer D so that both these inner wheel 1a and outer wheel 1b may be integrally joined together through the elastic material 2 filled in the spacer D to thereby be assembled into a full truck-roller 1.

In this embodiment, the spacer D, in which to fill the elastic material 2 is set at about 20 mm in its radial direction, and the outer peripheral surface of the inner wheel 1a and the outer peripheral surface of the outer wheel 1b is so set that an interval of approximately 20 mm may be secured in the radial direction.

In this embodiment, too, the elastic material 2 to be filled in the spacer D is selected from rubber, which is made up of unvulcanized crude rubber added with an extender. This crude rubber is filled in the spacer D under pressure, which is heated at a pressurized condition and maintained at a temperature of approximately 120° C. for about 30 to 40 min. Under this heated condition, the vulcanization treatment is carried out, to thereby transfer the crude rubber into vulcanized rubber. In this way, the rubber material is changed into the elastic material having the intended elasticity and tensile strength. The thus obtained material is integrally joined with the inner wheel 1a and the outer wheel 1b to be assembled into the full truck-roller 1.

The spacer D to be formed between the outer peripheral surface of this inner wheel 1a and the inner peripheral surface of the outer wheel 1b is for interposing the elastic material 2, with a view to integrally joining the inner wheel 1a and the outer wheel 1b as well as to absorbing vibrations from the outer wheel 1b. It may be sufficient that the annular elastic material 2 is interposed between the inner wheel 1a and the outer wheel 1b, in the direction seen from the axial direction. Also, seen from the longitudinal cross-sectional direction from the front face side which intersects with the axial direction, the spacer D may take various appropriate shape, such as, for example: a cylindrical shape which is in parallel with the supporting axle 3; a large drum shape, intermediate part in its longitudinal direction of which bulges outward; a small drum shape, the intermediate part of which constricts inward; a V-shape, intermediate part of which, in its axial direction, bends outside in a manner to protrude outward in its axial direction; or reverse V-shape with its intermediate part being bent inward so that its intermediate part may be fitted inside; or others. And, in this embodiment, the elastic material 2, as interposed, is formed in a small drum shape with its intermediate part being constricted in such a manner that it may absorb the stress in the thrust direction, which the truck-roller 1 running along its axial direction undergoes.

Also, the inner wheel 1a of the truck-roller 1, in this embodiment, has a staged portion formed for fitting the bearing 4 at both end positions of the bearing hole 10 in the axial direction thereof, where a slide bearing formed in a bush-shape is fitted in as the bearing member; while, at an intermediate position of the bearing hole 10 in its axial direction, there is formed an annular oil basin 11 which surrounds the supporting axle 3 together with the outer peripheral surface of the supporting axle 3. In the meantime, there is formed an annular fitting groove 12 concentric with the bearing hole 10 is formed, in both end surfaces in its axial direction, and a fitting groove 12 is communicatively connected to the abovementioned oil basin 11 through an oil hole 13.

And also, in this mode of construction, lubricating oil is filled in the oil basin 11, which is then inserted into the supporting axle 3, then one-half side of the oil seal 5 is inserted into the annular fitting groove 12, while, into the other half side of the oil seal 5, there is inserted into a separate bearing collar 6 formed in a separate ring-shape is inserted into the supporting axle 3, through an O-ring 60, and the collar 6 is fixed onto the supporting axle 3 to enable the collar 6 to be assembled to the supporting axle 3 in its set condition.

Further, this outer wheel 1b has a ring-shaped body 14, serving as a guide wheel, formed in the center part of the outer peripheral surface, in its axial direction. On both left and right sides of the ring-shaped body 14, there is formed a tread 15 of wide breadth to be abutted to the inner face of the rubber crawler g.

Also, as mentioned in the foregoing, the truck-roller (crawler) 1 in this embodiment is so constructed that the oil seal 5 and the bearing 4 are assembled on the inner surface of the annular fitting groove 12 and the bearing hole 10, which are provided on the shaft end parts of both left and right end sides of the inner wheel 1a. Then, lubricant oil is filled in the oil basin (or sump) 11 provided at the intermediate part in its axial direction, followed by inserting the supporting axle 3 into the bearing hole 10 of the shaft center part, and then a supporting axle 3 is fittingly inserted into the bearing hole 10 of the shaft and then the bearing collar 6 is inserted and fitted in both axial end parts of the supporting axle 3 to be fixed onto the supporting axle 3 by means of a snap ring 7, thereby constructing to form the truck-roller in a single unit body, in the state of its being held on the supporting axle 3, and, in the state of its being assembled in this single truck-roller (crawler), it can be assembled and supported on the opposite side frame such as truck frame b, and others.

That is to say, at the end face of both shaft end part of the supporting axle to be inserted and fitted into the bearing hole 10 at the shaft center part of the truck-roller 1, there is formed tapped holes 30 for assembling and supporting the truck-roller, and, when this truck-roller 1 is to be supported pivotally on the opposite side frame such as truck frame b, and others, the end face of both shaft end parts of the supporting axle 3, which has been fittingly inserted and assembled in the bearing hole 10, is abutted to the inner wall surface of the opposite side frame 8, and a bolt 9 to be inserted from the outer wall surface side of the frame 8 into the bolt hole 80 to be opened at a predetermined fitting position of the frame 8, from the outer wall surface side of the frame 8 is screwed into the tapped holes 30 provided on the end face of the shaft end part of the supporting axle, thereby pivotally supporting the bolt 9 to the frame 8 in its state of being assembled and pivotally supported on the supporting axle 3.

Although, in the foregoing, the present invention has been described in detail with reference to the specific mode of embodiment as shown in the accompanying drawing, it should be understood that the invention is not limited to the embodiment alone, but any changes and modifications may be made within the spirit and scope of the invention as recited in the appended claims.

What is claimed is:

1. A vibration isolating device for a truck-loader type vehicle, said device being characterized in that a truck-roller (1) to be pivotally supported on a truck frame (b), which is fittingly mounted on both left and right sides of the vehicle body (a) of said truck-loader type vehicle is separately and individually shaped for an inner wheel (1a) and an outer wheel (1b), said inner wheel (1a) and an outer wheel (1b) being joined together between an outer peripheral surface of said inner wheel (1a) and an outer peripheral surface thereof with a spacer (D) being interposed therebetween, an elastic material (2) made of rubber, and others being pressurized and fitted under pressure within said spacer (D), to thereby absorb vibrations by means of said elastic material (2) filled within said interval spacer (D).

2. A vibration isolating device for a truck-loader type vehicle, as set forth in claim 1, said device being characterized in that said interval spacer (D) between said outer peripheral surface of said inner wheel (1a) and an inner peripheral surface of said outer wheel (1b), where said elastic material (2) made of rubber, etc. is to be filled, said spacer (D) being formed in a shape which runs along a circular arc having a large radius of curvature having its center point outside said outer wheel (1b), and being formed in a shape with the outer peripheral surface of the inner wheel (1a) and the inner peripheral surface of the outer wheel (1b) being made parallel each other, thereby restricting movement in its thrust direction.
